(19) United States
(12) Patent Application Publication
(10) Pub. No.: US 2005/0206640 A1
(43) Pub. Date: Sep. 22, 2005

(54) Image display panel and level shifter

(75) Inventors: Mitsuhide Miyamoto, Kokubunji (JP); Hajime Akimoto, Kokubunji (JP)

Correspondence Address: Stanley P. Fisher;Reed Smith LLP, Suite 1400, 3110 Fairview Park Drive, Falls Church, VA, 22042-4503, US

(73) Assignee: Hitachi Displays, Ltd.

(21) Appl. No.: 10/913,443

(22) Filed: Aug. 9, 2004

(30) Foreign Application Priority Data
Mar. 17, 2004 (JP) 2004-075724

(51) Int. Cl. G09G 5/00

(52) U.S. Cl. 345/211

(57) ABSTRACT

The invention provides an image display panel to which a low voltage can be directly applied without largely increasing the number of input terminals. In the image display panel, n pieces of level shifters LSa for boosting n pieces of input signals VIN supplied from the outside are provided. An input of each of the level shifters is connected to one end of one of capacitances via a switching element. The other end of the capacitance C1 is grounded and the other ends of capacitances C2 and C3 are grounded via switching elements. Each of the switching elements operates according to complementary clocks CLK and CLKB of positive and negative phases boosted by a level shifter LS0 to switch connection of the capacitances from parallel connection to serial connection, thereby boosting the voltage by three times. The boosted voltage is output via an inverter. In such a manner, the image display panel can boost an input signal by two complementary clock signal lines without requiring a number of inversion signals. Since an input signal is not directly connected to the gate of an FET, it is not influenced by variations in thresholds.

### CLAIMS OF PRIORITY

The present application claims priority from Japanese application serial no. JP 2004-075724, filed on Mar. 17, 2004, the content of which is hereby incorporated by reference into this application.

### BACKGROUND OF THE INVENTION

1. Field of the Invention

The present invention relates to an image display panel to which a low voltage signal of 2V or less can be input and a level shifter.

2. Description of the Related Art

A liquid crystal display panel of an active matrix drive type is used for an image display part in a notebook computer, a mobile phone, a PDA (Personal Digital Assistant), or the like. An active matrix drive organic electro-luminescence (EL) display panel has advantages such that it is thinner than a liquid crystal display panel and is of a light emitting type and, moreover, has high speed of response. In the active matrix drive display panels, TFTs (Thin Film Transistors) are formed on a transparent substrate and pixels are driven by the TFTs, thereby displaying an image.

The TFTs include a TFT made of amorphous silicon and a TFT made of polysilicon. The TFT made of polysilicon has, although it's manufacturing cost is higher, advantages such that mobility of a silicon thin film is high and a drive circuit other than a pixel circuit can be also formed on a transparent substrate. By utilizing the advantages, a liquid crystal display panel on which a shift register, a digital/analog (D/A) converter, and the like are mounted is being developed by using polysilicon TFTs.

By mounting the circuits on a transparent substrate, the number of parts of the external circuits can be reduced, and lower price of a liquid crystal module can be realized. Further, if various circuits can be built in an image display panel using a liquid crystal, organic EL, or the like in future, there is the possibility that an image display panel which can be directly connected to a system such-as a graphic controller without using a circuit such as a liquid crystal driver is developed.

In this case, however, there is a problem such that the operation voltage of a TFT circuit formed in the image display panel and that of an external system are different from each other. The TFT circuit in the image display panel operates at a voltage higher than that of an external system. Consequently, for example, in a liquid crystal module currently manufactured, a signal voltage is boosted by a level shifter provided on the outside of the liquid crystal display panel and the resultant signal voltage is supplied into the liquid crystal display panel. In future, to reduce the number of chips added on the outside of the image display panel, the level shifter has to be also manufactured by TFTs.

FIG. 10 shows an example of a general level shifter conventionally used as a first prior art (refer to, for example, Japanese Patent Laid-open No. Hei 4-268818 (FIG. 1)).

The level shifter operates in such a manner that an input signal VIN is applied to a CMOS inverter constructed by an nMOS transistor NM21 and a pMOS transistor PM22, and an inverted signal VINB of the input signal is applied to a CMOS inverter constructed by an nMOS transistor NM22 and a pMOS transistor PM24. The level shifter has advantages of high speed of response.

FIG. 11 shows a level shifter as a second prior art. Since this circuit does not need the inverted input signal VINB, the configuration is simple (refer to, for example, Japanese Patent Laid-open No. 2003-115758 (FIG. 1) and SID (Society for Information Display) 02DIGEST, p. 690).

### SUMMARY OF THE INVENTION

The first prior art can realize high speed of response but has a drawback that the two input signals VIN and VINB are necessary. Consequently, in the case of mounting the level shifter on an image display panel, the number of terminals for input signals becomes double and the configuration of a liquid crystal module becomes complicated.

In the second prior art, the input signal VIN is received by the gate terminal of an nMOS transistor NM32 via an nMOS transistor NM31 for switch. Therefore, in order to boost an input signal of 2V or less, variation of the threshold voltage of the nMOS transistor NM32 has to be suppressed to 2V or less and there is a problem in processing. Actually, the circuit is used as a level shifter for boosting an input signal of 3V in SID 02DIGEST, p. 690.

An object of the invention is to provide an image display panel which can be directly connected to a system such as a graphic controller without using a circuit such as a liquid crystal driver.

Another object of the invention is to provide a level shifter capable of boosting an input signal of low voltage of 2V or less to a predetermined voltage by using TFTs without requiring an inverted input signal.

An example of representative means of the invention is as follows. The invention provides an image display panel having a plurality of signal input terminals, comprising a plurality of level shifters for boosting an input signal supplied from the outside of the image display panel to the signal input terminals, each of the level shifters including: a plurality of capacitances; a plurality of switching elements constructed by field effect transistors; and a control signal for controlling the plurality of switching elements, wherein the input signal is boosted via the plurality of capacitances and a drain-source path of the plurality of switching elements, that is, without being directly connected to the gate terminals.

In the image display panel, preferably, the control signals are two signals generated from a signal of a positive phase and a signal of a negative phase input from the outside of the panel.

A level shifter according to the invention is characterized by comprising: two inputs of the input signal and a constant voltage input equal to a center voltage value of an amplitude of the input signal; a control signal input from the outside; first and second switching elements connected to the two inputs; a capacitance whose one end is connected to a terminal on the side opposite to the input side of each of the first and second switching elements; a CMOS inverter circuit whose input side is connected to the other end of the capacitance; and a third switching element for connecting an input and an output of the CMOS inverter circuit.

An another level shifter according to the invention has a plurality of capacitances, a plurality of switching elements constructed by field effect transistors, and a control signal for controlling the plurality of switching elements, and is characterized in that the input signal is boosted via the plurality of capacitances and a drain-source path of the field effect transistors.

In this case, preferably, the control signals are two signals generated from a signal of a positive phase and a signal of a negative phase.

Further, the input signal is connected to one of terminals of the plurality of switching elements and the other terminal is connected to another capacitance in the plurality of capacitances, and connection form of the plurality of capacitances can be switched between parallel connection and serial connection by the control signal.

### BRIEF DESCRIPTION OF THE DRAWINGS

FIG. 1 is-a block diagram showing an embodiment of an image display panel according to the invention.

FIG. 2 is a circuit configuration diagram showing an embodiment of a level shifter according to the invention.

FIG. 3 is a timing chart showing operation of the level shifter of FIG. 2.

FIG. 4 is a circuit configuration diagram showing a case where the level shifter of FIG. 3 is mounted on the image display panel of FIG. 1.

FIG. 5 is a circuit configuration diagram showing another embodiment of the level shifter according to the invention.

FIG. 6 is an explanatory diagram for obtaining input and output voltages of an inverter INV3 in a reset state of the level shifter illustrated in FIG. 5.

FIG. 7 is a diagram showing input/output waveforms in a normal operation state of the level shifter illustrated in FIG. 5.

FIG. 8 is a timing chart showing operation of the level shifter illustrated in FIG. 5.

FIG. 9 is a circuit configuration diagram showing a case where the level shifter of FIG. 5 is mounted on the image display panel illustrated in FIG. 1.

FIG. 10 is a circuit configuration diagram showing a first prior art of the level shifter.

FIG. 11 is a circuit configuration diagram showing a second prior art of the level shifter.

### DETAILED DESCRIPTION OF THE PREFERRED EMBODIMENTS

Some preferred embodiments of the invention will be described in detail hereinbelow with reference to the appended drawings.

### First Embodiment

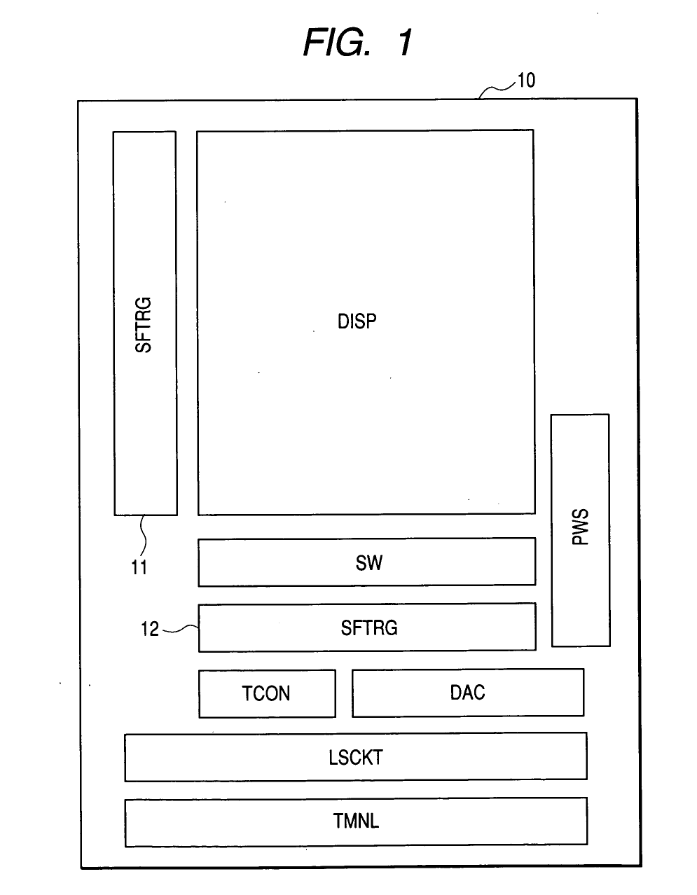

FIG. 1 is a block diagram showing an embodiment of an image display panel according to the invention. Wirings and the like are omitted. In an image display panel 10, by using TFTs, a pixel display part DISP in which a plurality of pixels are arranged in matrix, a shift register (SFTRG) 11 for driving scanning lines of the pixel display part, a switch circuit part SW for transferring pixel display signal data in the X direction, a shift register 12 for driving the switch circuit part, a digital/analog converter DAC, a timing controller TCON for controlling timings of pixel display, a level shifter part LSCKT for boosting an input signal, and a power source circuit PWS are formed. All of digital signals supplied from a terminal part TMNL to the image display panel 10 are boosted by the level shifter part LSCKT and sent to the circuit blocks in the image display panel.

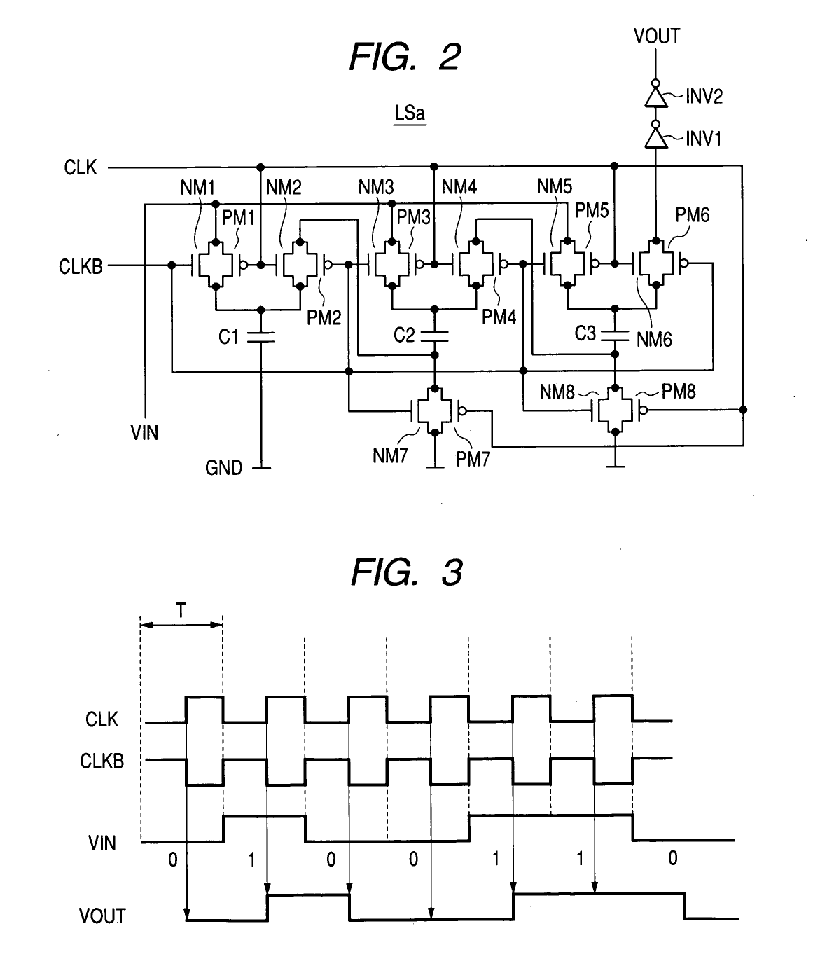

FIG. 2 shows a level shifter of the embodiment. A level shifter LSa can boost a signal voltage by three times by switching the connection of three capacitances C1, C2, and C3 from parallel connection to direct connection. The level shifter has three input signals of the input signal VIN, a clock signal CLK, and an inverted clock signal CLKB and one output VOUT. The input signal VIN is connected to the capacitance C1 and switching transistors NM2 and PM2 via switching transistors NM1 and PM1. Similarly, the input signal VIN is connected to the capacitance C2 and switching transistors NM4 and PM4 via switching transistors NM3 and PM3. Further, the input signal VIN is connected to the capacitance C3 and switching transistors NM6 and PM6 via switching transistors NM5 and PM5.

The level shifter LSa has a configuration that the input signal IN is not directly connected to the gate terminal of a field effect transistor (FET) device, so that the operation of the level shifter is not influenced by variations in the threshold voltage of the device. The level shifter LSa can boost an input signal of low voltage of 2V or less.

FIG. 3 shows a timing chart of the level shifter LSa of the embodiment. As shown in FIG. 3, the clock signal CLK and the inverted clock signal CLKB are clock signals having the same signal cycle as the cycle T of the input signal VIN. FIG. 3 shows the operation performed when a digital signal of “0100110” is input as the input signal VIN.

By the clock signal CLK and the inverted clock signal CLKB, in the first half of one cycle of the input signal, the switching transistors NM1, NM3, NM5, NM7, NM8, PM1, PM3, PM5, PM7 and PM8 shown in FIG. 2 are set to the on state and the switching transistors NM2, NM4, NM6, PM2, PM4, and PM6 are set to the off state. By the operation, the three capacitances C1, C2, and C3 are connected in parallel between the input signal VIN and GND, and a charge according to a voltage value of the input signal is accumulated in each of the capacitances.

In the latter half of one cycle of the input signal VIN, the switching transistors NM2, NM4, NM6, PM2, PM4, and PM6 are set to the on state and the switching transistors NM1, NM3, NM5, NM7, NM8, PM1, PM3, PM5, PM7 and PM8 are set to the off state. By the operation, the three capacitances C1, C2, and C3 are connected in series, and the voltage of an electrode on the capacitance C3 becomes three times as that of the input signal VIN. The voltage is output as the output signal VOUT via inverters INV1 and INV2.

In the example, three capacitances are used on assumption that a level shifter is employed in which a drive voltage of a circuit in the image display panel 10 is 5V and a signal having an amplitude of about 1.6V to 1.8V is supplied from the outside.

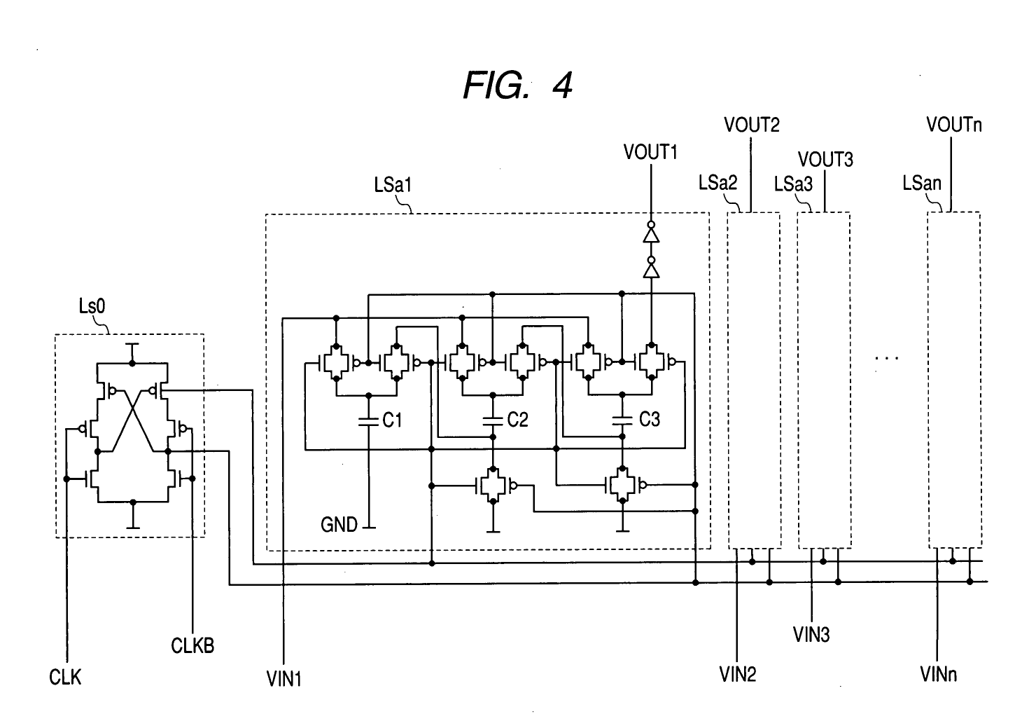

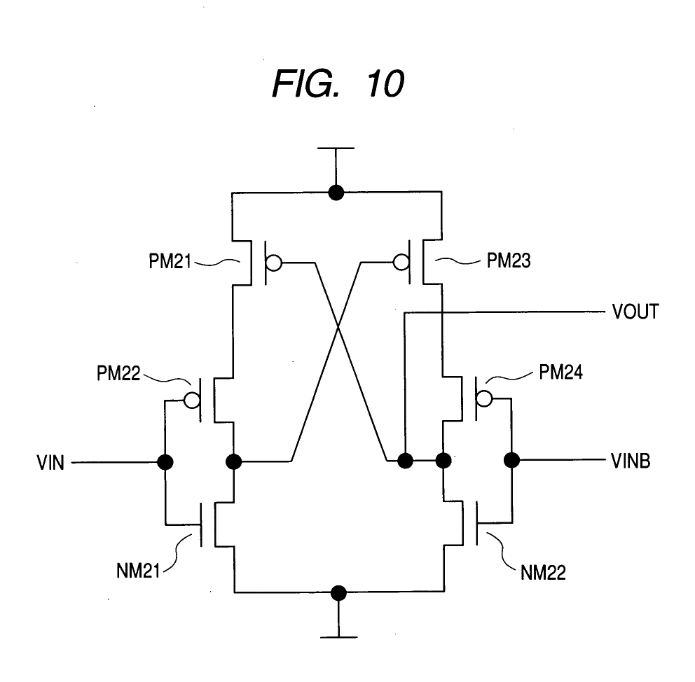

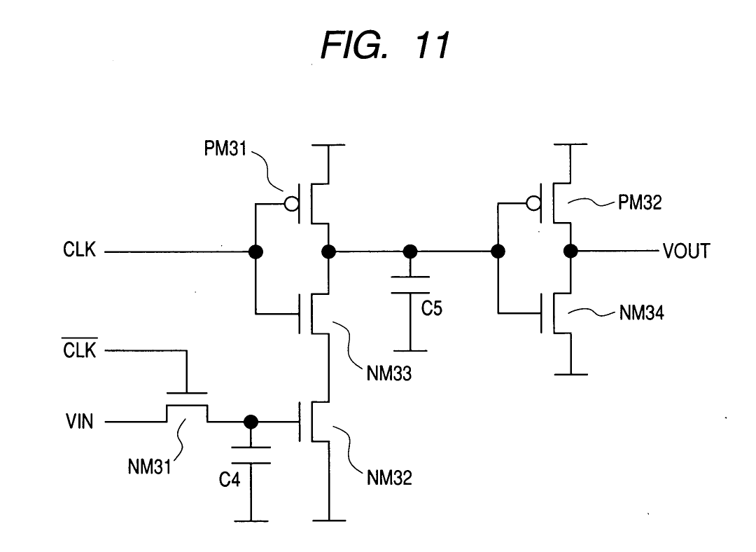

FIG. 4 is a circuit diagram showing the case where the level shifter part LSCKT illustrated in FIG. 1 is formed by using “n” pieces of level shifters of the embodiment (LSa1 to LSan). In the diagram, two control signals of the clock signal CLK and the inverted clock signal CLKB, n input signals VIN1 to VINn, and n output signals VOUT1 to VOUTn are connected. The clock signal CLK and the inverted clock signal CLKB are boosted by a circuit LS0 similar to the conventional level shifter illustrated in FIG. 10 and, after that, control the other n level shifters LSa1 to LSan.

N pieces of the level shifters LSa1 to LSan have the same configuration as that of the level shifter LSa shown in FIG. 2, boost the input signals VIN1 to VINn, respectively, and output output signals VOUT1 to VOUTn. With the configuration, only by adding two signals of the clock signal CLK and the inverted clock signal CLKB, an input signal can be boosted.

### Second Embodiment

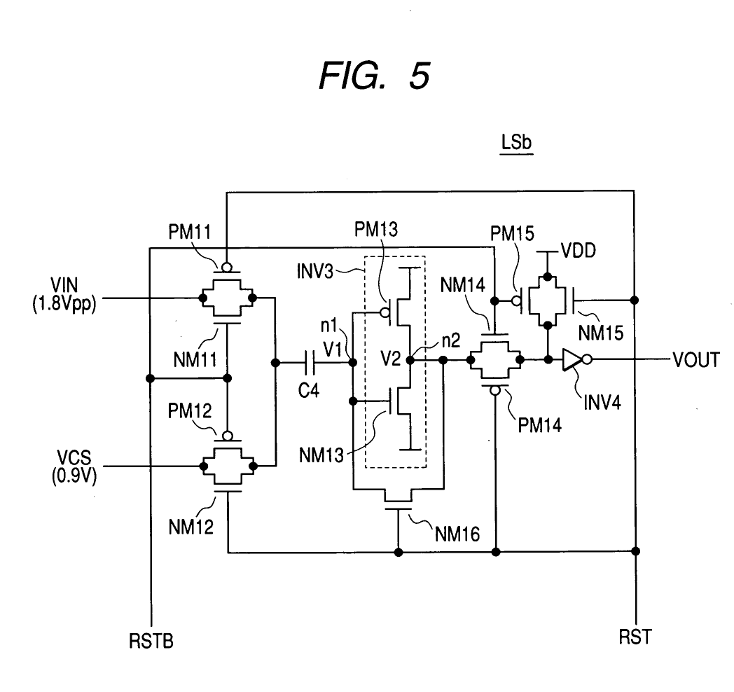

FIG. 5 is a circuit diagram showing another embodiment of a level shifter according to the invention. The level shifter will be described hereinbelow. In the second embodiment, a case where a level shifter LSb boosts the input signal VIN having an amplitude of 1.8V to a signal having an amplitude of 5V and outputs the boosted signal will be described as an example. The level shifter LSb has four input signals of the input signal VIN, a constant voltage input VCS, a reset signal RST, and an inverted reset signal RSTB and one output signal VOUT. The voltage value of the constant voltage input VCS is the half of VIN, that is, 0.9V, and the amplitude of the reset signal RST is 5V.

The input signal VIN of the level shifter LSb is connected to one of terminals of a capacitance C4 and switching transistors NM12 and PM12 via switching transistors NM11 and PM11. The other terminal of the capacitance C4 is connected the input of an inverter INV3 constructed by a pMOS transistor PM13 and an nMOS transistor NM13 and is connected to a switching nMOS transistor NM16 for coupling the input and output of the inverter INV3.

An output of the inverter INV3 is connected to the input of an inverter INV4 via switching transistors NM14 and PM14 and an output of the inverter INV4 is sent as the output signal VOUT to the outside. An input of the inverter INV4 is also connected to a power source VDD of 5V via switching transistors NM15 and PM15. In the configuration as well, like the level shifter of FIG. 2, the input signal VIN is not directly connected to the gate terminal of an FET device, so that the operation of the level shifter is not influenced by variations in the threshold voltage of the FET device.

The operation of the level shifter LSb is performed in two states of a reset state and a normal operation state. The reset state is set by applying 5V as the reset signal RST and 0V as the inverted reset signal RSTB. The normal operation state is set by applying 0V as the reset signal RST and 5V as the inverted reset signal RSTB. In the reset state, the nMOS transistors NM12, NM15, and NM16 and the pMOS transistors PM12 and PM15 are set to the on state. In the normal operation state, the nMOS transistors NM11 and NM14 and the pMOS transistors PM11 and PM14 are set to the on state.

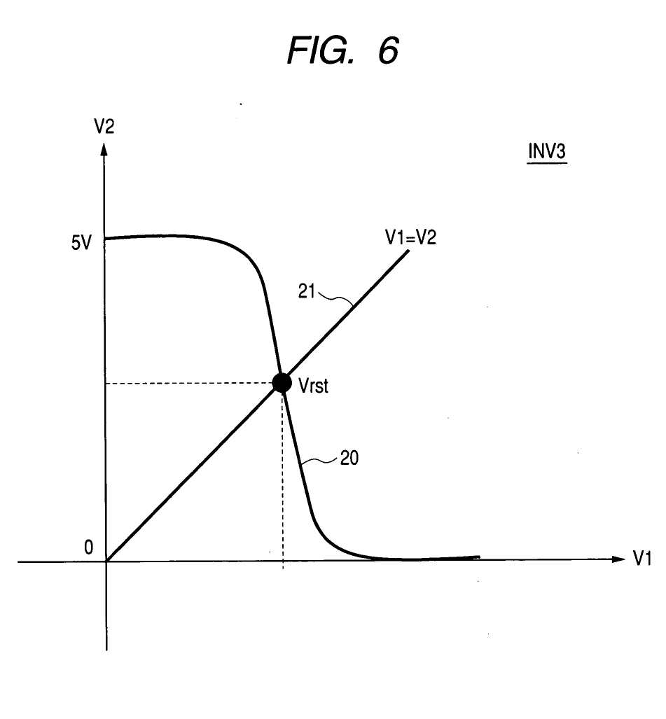

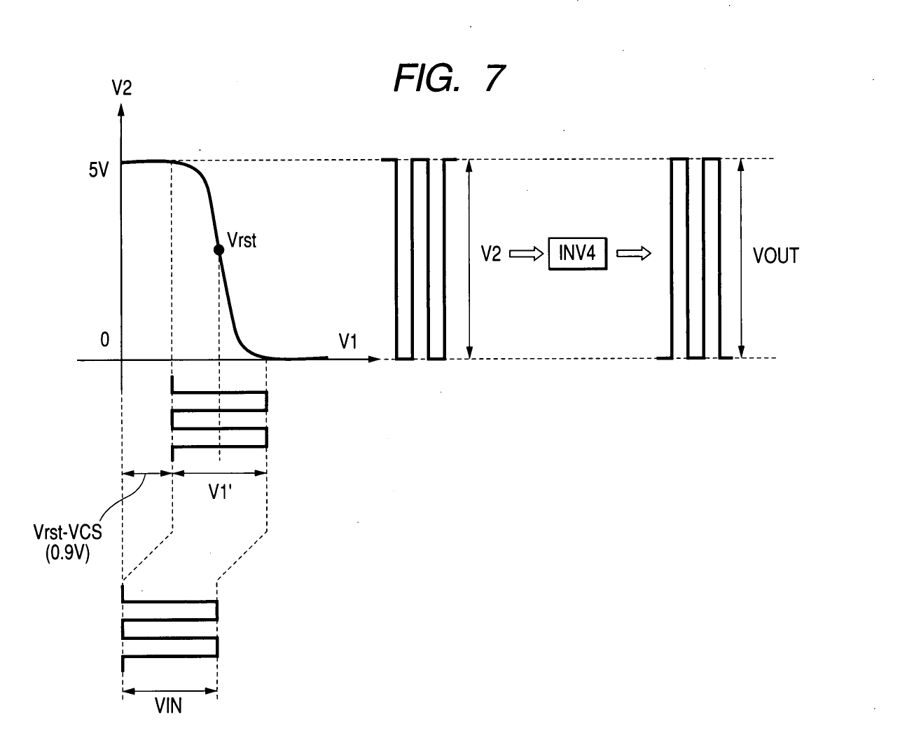

Next, the operations in the reset state and the normal operation state will be described in detail by using FIGS. 6 and 7. FIG. 6 is a diagram in which the X and Y axes indicate an input voltage V1 at a node n1 of the inverter INV3 and an output voltage V2 at a node n2, respectively, and the voltages V1 and V2 at the nodes n1 and n2 are obtained in the reset state. In the reset state, the nMOS transistor NM16 is turned on, an input and an output of the inverter INV3 are connected to each other, and the potentials become the same. Consequently, the input voltage V1 and the output voltage V2 of the inverter INV3 become a voltage Vrst at an intersecting point of an inverter input/output characteristic curve 20 and a straight line 21 of V1=V2 on the graph. At this time, the switching transistors PM12 and NM12 are also turned on in FIG. 5, so that a constant voltage VCS (0.9V) is applied to the left terminal of the capacitance C4. Therefore, a voltage of Vrst-VCS is applied to the capacitance C4. Further, at this time, the switching transistors PM15 and NM15 enter the on state, so that the input of the inverter INV4 becomes 5V and 0V is output as the output signal VOUT.

FIG. 7 shows the waveforms of an output signal in the normal operation state. In the normal operation state, the switching transistors PM11 and NM11 are set to the on state, and the input signal VIN is connected to the capacitance C4. Since the voltage Vrst-VCS is held in the capacitance C4, the voltage V1 of the node n1 becomes VIN+Vrst-VCS, that is, VIN+Vrst-0.9V and has a voltage waveform V1′ in which the voltage is amplified around Vrst as a center. By the input voltage waveform V1′, the voltage V2 of the output node n2 of the inverter INV3 has the waveform of 5V amplitude. Therefore, the output signal VOUT of the level shifter LSb itself has the waveform of 5V amplitude obtained by inverting the voltage V2 of the node n2 by the inverter INV4.

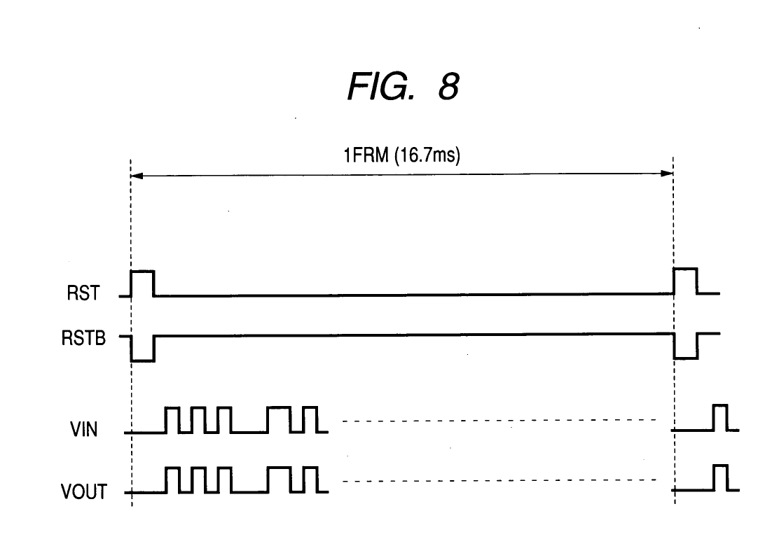

FIG. 8 shows the timing chart of the level shifter LSb of the second embodiment. The chart shows time required to draw one picture on the image display panel, that is, input and output signals in one frame (FRM). In this case, one frame is set as 16.7 ms (converted by 60 frames/sec) As shown in FIG. 8, one wave of each of the reset signal RST and the inverted reset signal RSTB is formed every frame, and resetting operation is performed at the start of each frame. The resetting operation is performed at the intervals for the following two reasons.

(1) In the resetting operation, the voltage of the capacitance C4 is set to Vrst-VCS. However, in the normal operation state, the charges in the capacitance C4 escape gradually due to leak and the voltage of the capacitance C4 changes. Thus, the resetting has to be performed periodically.

(2) Since the level shifter LSb cannot boost an input signal during the resetting operation, the resetting operation has to be performed at the time of the beginning or end of a frame in which image data is not input.

Although it is obvious from the reason of (2), the resetting operation may be performed at the end of a frame.

By increasing the capacity of the capacitance C4, a voltage change amount of the capacitance C4 due to leak is reduced, and the resetting operation may be performed every several frames.

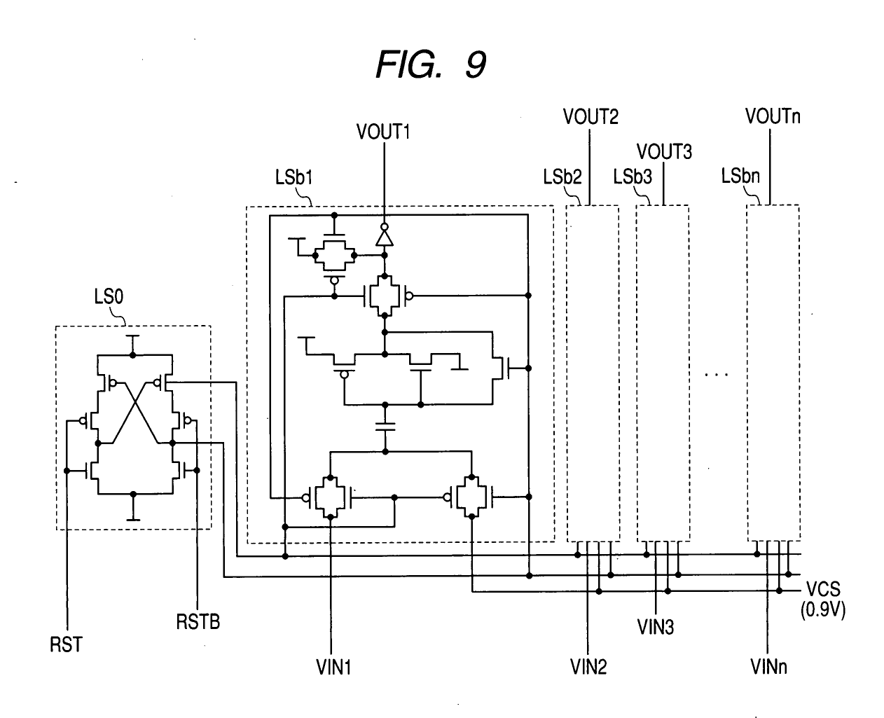

FIG. 9 shows an example of the case of forming the level shifter part LSCKT illustrated in FIG. 1 by using n pieces of level shifters LSb (LSb1 to LSbn) of FIG. 5. In FIG. 9, two control signals of the reset signal RST and the inverted reset signal RSTB, n input signals VIN1 to VINn, a constant voltage input VCS (0.9V), and n output signals VOUT1 to VOUTn are connected. The reset signal RST and the inverted reset signal RSTB are boosted by a circuit LS0 similar to the conventional level shifter illustrated in FIG. 10 and, after that, control the other n level shifters LSb1 to LSbn. The n level shifters LSb1 to LSbn have the same configuration as that of the level shifter LSb illustrated in FIG. 5, boost the input signals 1 to n, and output the output signals 1 to n. With the configuration, only by adding the two signals of the reset signal RST and the inverted reset signal RSTB and the constant voltage input VCS, the input signal can be boosted.

Although the preferred embodiments of the invention have been described above, obviously, the invention is not limited to the foregoing embodiments but the designing can be variously changed without departing from the spirits of the invention. For example, although an input signal is boosted by using three capacitances in the configuration of FIG. 2, it is also possible to increase the capacitances in accordance with a necessary voltage, and boost an input signal to a higher voltage. Although the constant voltage input VCS is set to 0.9V in the configuration of FIG. 5, obviously, it can be changed in accordance with a necessary amplitude voltage of the input signal voltage.

According to the invention, the level shifter can boost a low voltage signal without requiring an inverted signal. By providing the level shifter in an image display panel, the image display panel does not need an inverted signal. Thus, without largely increasing the number of input terminals, an image display panel to which a low voltage signal of 2V or less can be directly input is realized.

1. An image display panel having a plurality of signal input terminals, comprising a plurality of level shifters for boosting an input signal supplied from the outside of said image display panel to said signal input terminals, each of said level shifters comprising:
a plurality of capacitances;
a plurality of switching elements constructed by field effect transistors; and
a control signal for controlling said plurality of switching elements,
wherein said input signal is boosted via said plurality of capacitances and a drain-source path of said plurality of switching elements.

2. The image display panel according to claim 1, wherein said control signals are two signals generated from a signal of a positive phase and a signal of a negative phase input from the outside of the panel.

3. The image display panel according to claim 2, wherein said input signal is connected to one of terminals of each of said plurality of switching elements in said level shifters, the other terminals are connected to the different capacitances, and a connection form of said plurality of capacitances is switched between parallel connection and serial connection in accordance with said control signals.

4. An image display panel having a plurality of signal input terminals, comprising:
a plurality of level shifters for boosting an input signal input from the outside of the panel to said signal input terminals; and
a control signal for controlling said plurality of level shifters,
each of said level shifters comprising:
two inputs of said input signal and a constant voltage input equal to a center voltage value of an amplitude of said input signal;
first and second switching elements connected to said two inputs;
a capacitance whose one end is connected to a terminal on the side opposite to the input side of each of said first and second switching elements;
a CMOS inverter circuit whose input is connected to the other end of said capacitance; and
a third switching element for connecting an input and an output of said CMOS inverter circuit.

5. The image display panel according to claim 4, wherein an output of said CMOS inverter circuit is output as a boosted output signal of said level shifter via a fourth switching element and an inverter.

6. The image display panel according to claim 5, wherein said control signals are a reset signal and an inverted reset signal as an inverted signal of the reset signal which are input from the outside, and said first to fourth switching elements are controlled by said reset signal and said inverted reset signal.

7. The image display panel according to claim 6, wherein a reset operation to be performed by said reset signal is executed by said reset signal once per frame of the image display panel on start or end of a frame period.

8-10. (canceled)
